(19) United States
(12) Patent Application Publication
(10) Pub. No.: US 2023/0009557 A1
(43) Pub. Date: Jan. 12, 2023

(54) ELECTROCHROMIC DEVICE WITH IMPROVED SWITCHING SPEED

(71) Applicant: Solutia Inc., St. Louis, MO (US)

(72) Inventors: Shanzuo Ji, Beachwood, OH (US); Steven V. Haldeman, Hampden, MA (US); Francois Andre Koran, Longmeadow, MA (US)

(73) Assignee: Solutia Inc., St. Louis, MO (US)

(21) Appl. No.: 17/757,112

(22) PCT Filed: Dec. 17, 2020
(86) PCT No.: PCT/US2020/065639

§ 371 Date: Jun. 9, 2022

Related U.S. Application Data
(60) Provisional application No. 62/950,303, filed on Dec. 19, 2019.

(51) Int. Cl. G02F 1/163; G02F 1/153; G02F 1/1333; G02F 1/137

(52) U.S. Cl. CPC G02F 1/163; G02F 1/1533; G02F 1/133345; G02F 1/137; G02F 2202/16

(57) ABSTRACT

An electrochromic device is disclosed. The electrochromic device includes (i) a first substrate with an electrically conductive layer on an inner surface thereof; (ii) a second substrate with an electrically conductive layer on an inner surface thereof; (iii) an electrochromic assembly comprising at least one electrochromic layer; (iv) a first bus bar pair comprising a positive bus bar electrically connected to the electrically conductive layer of the first substrate and a negative bus bar electrically connected to the electrically conductive layer of said second substrate; and (v) a second bus bar pair including a positive bus bar electrically connected to the electrically conductive layer of the first substrate and a negative bus bar electrically connected to the electrically conductive layer of the second substrate. A process for reversibly changing the optical properties of an electrochromic device that includes at least one electrochromic layer is also described.

### FIELD OF THE INVENTION

The present invention relates to electrochromic devices and processes for process for reversibly changing the optical properties of an electrochromic device that includes at least one electrochromic layer.

### BACKGROUND OF THE INVENTION

Electrochromic devices are a type of electrically switchable or dynamic or electrically active devices that are known in the art. The term “electrochromic” is typically used in the art to describe a class of switchable or activatable devices, as well as related materials, which reversibly change one or more optical properties in response to an insertion or extraction of ions or electrons created by electrical stimulus such as for example an applied or removed current or voltage potential. The device or material exhibits a first defined optical property state in a first or starting electrical condition and a second optical property state when that electrical condition is changed. Optical properties of electrochromic devices or materials typically reversibly changed through chemical oxidation/reduction and include for example electromagnetic energy (such as visible, infrared, ultraviolet or other wavelength) transmissivity, reflectivity, tint, color and refractive index. By way of non-limiting example, in some electrochromic devices visible transmissivity can be reversibly transitioned from a first relatively low level to a second relatively higher level (sometimes referred to as “bleaching”) via application of a voltage potential. In another example, visible light transmissivity can be reversibly transitioned from a first relatively high level to a second relatively low level (sometimes referred to as “darkening”) via application of a voltage potential.

Electrochromic devices and materials have numerous useful applications such as, for example, as a component of switchable glazings (sometimes referred to as “smart” glazings) that can be utilized as a component of automotive windows and sunroofs and architectural skylights and windows, mirrors, displays and the like. Electrochromic devices are described for example in U.S. Pat. Nos. 8,218,223 and 8,717,658, the contents and descriptions of which are hereby incorporated herein by reference.

The comfort, energy-saving and visually aesthetic advantages of electrochromic devices are creating an ever-increasing consumer demand for their adoption as components in the above-described end-use applications. As well documented in the prior art, however, some electrochromic devices and their related materials exhibit performance drawbacks that have hampered their market penetration and corresponding manufacturer and consumer acceptance. At the forefront of these drawbacks is “switching speed”, which generally refers to the rate at which an electrochromic device transitions from a first optical state to a second optical state when a voltage potential is applied or removed. As a general proposition, consumers (and therefore manufacturers) desire products which transition from one optical state to another in the shortest possible time—and many prior art electrochromic materials and devices simply do not transition at a commercially satisfactory rate.

Another drawback often perceived by consumers relates to uneven and non-uniform switching or transition that can be caused by localized differences and/or variations in the applied voltage potential across the device. In such circumstances, the transmissivity of the electrochromic device will initially change more so in the vicinity of the applied potential, often at the edges of the device, with transmissivity gradually and progressively changing towards the center of the device only as the differences in the applied potential across the device equilibrate toward zero. Further, from a design perspective, it is often desired for an electrochemical device to transition between optical states in a well-defined and specified direction based on the utility of the device.

As demand for electrochromic devices expands to larger sized end-use applications such as vehicle panoramic sunroofs and architectural skylights, commercially acceptable transition uniformity and switching speed are especially paramount to market success of the product; however, innovations around both device construction (see for example U.S. Pat. No. 8,717,658) and material composition have yet to resolve these performance challenges. An unmet need for electrochromic devices with commercially acceptable switching speed, direction and uniformity therefore continues to exist.

### SUMMARY OF THE INVENTION

In a first aspect, the present invention is directed to an electrochromic device. The electrochromic device of the present invention includes (i) a first substrate with an electrically conductive layer on an inner surface thereof; (ii) a second substrate with an electrically conductive layer on an inner surface thereof; (iii) an electrochromic assembly including at least one electrochromic layer; (iv) a first bus bar pair that includes a positive bus bar electrically connected to the electrically conductive layer of the first substrate and a negative bus bar electrically connected to the electrically conductive layer of the second substrate; and (v) a second bus bar pair that includes a positive bus bar electrically connected to the electrically conductive layer of the first substrate and a negative bus bar electrically connected to the electrically conductive layer of the second substrate.

In a second aspect, the present invention is directed to a process for reversibly changing the optical properties of an electrochromic device that includes at least one electrochromic layer. The process of the present invention includes (i) applying a voltage potential across a first bus bar pair in electrical connectivity with the at least one said electrochromic layer, wherein the first bus bar pair includes a first positive bus bar and a first negative bus bar; and (ii) applying a voltage potential across a second bus bar pair, said second bus bar pair comprising a second positive bus bar and a second negative bus bar.

Further aspects of the invention are as disclosed and claimed herein.

### BRIEF DESCRIPTION OF THE DRAWINGS

FIG. 1 is a cross-sectional view of a prior art electrochromic device;

FIG. 2 is a cross-sectional view of an embodiment of the electrochromic device of the present invention;

FIG. 3 is a cross-sectional view of an embodiment of the electrochromic device of the present invention;

FIG. 4 is a side elevational view of the embodiment of the device of the present invention set forth in FIG. 2;

FIG. 5A is an exploded view of one corner of the embodiment shown in FIG. 4;

FIG. 5B is an exploded view of one corner of the embodiment shown in FIG. 4;

FIG. 6 is a graphical plot representing certain data generated in the evaluation set forth in Example 2 herein; and

FIG. 7 is a graphical plot representing certain data generated in the evaluation set forth in Example 2 herein.

### DETAILED DESCRIPTION

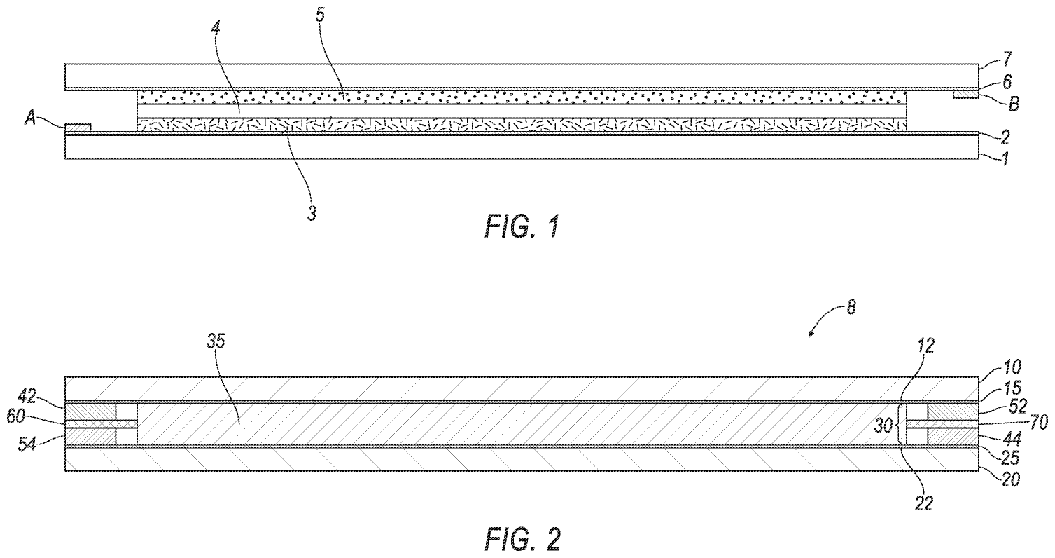

A typical prior art electrochromic device is depicted FIG. 1 herein. A glass substrate 1 is coated with a first electrode layer 2, on which is coated a first layer 3 in which ions may be reversibly inserted. The first layer 3 in which ions may be reversibly inserted is electrochromic in nature. An ion-conducting layer 4 separates the first layer in which ions may be reversibly inserted, from the second layer 5 in which ions may be reversibly inserted. The second layer 5 in which ions may be reversibly inserted acts as a counter electrode to the first layer 3 in which ions may be reversibly inserted and may or may not be electrochromic in nature. The layered structure of the device is completed by a second glass substrate 7 which is coated with a second electrode layer 6. The electrode layers (2, 6) are provided with electrical contacts (A and B) between which an electrical potential may be applied.

The electrochromic device of the present invention, generally depicted as 8 in FIGS. 2 through 4, includes (i) a first substrate 10 with an electrically conductive layer 15 on an inner surface 12 thereof; (ii) a second substrate 20 with an electrically conductive layer 25 on an inner surface 22 thereof; (iii) an electrochromic assembly 30 comprising at least one electrochromic layer 35; (iv) a first bus bar pair including a positive bus bar 42 electrically connected to the electrically conductive layer 15 of said first substrate 10 and a negative bus bar 44 electrically connected to the electrically conductive layer 25 of said second substrate 20; and (v) a second bus bar pair comprising a positive bus bar 52 electrically connected to the electrically conductive layer 15 of the first substrate 10 and a negative bus bar 54 electrically connected to the electrically conductive layer 25 of the second substrate 20.

First and second substrates are preferably formed from a polymeric material such as polyethylene terephthalate (PET), polyethylene naphthalate (PEN), cellulose esters, acrylics, polycarbonates, cyclic olefin copolymers and the like, and are preferably flexible films with a high visible light transmission level (% VLT), such as a % VLT of at least 80% or more. Thicknesses for the first and second substrates may be selected depending on for example the end-use applications for the device but will typically range from about 0.5 to 8 mils (0.013 to 0.20 mm), or from about 1 to 4 mils (0.025 to 0.1 mm), or about 2 to 3 mils (0.05 to 0.075 mm). It will be understood by a person ordinary skill that the individual substrate thicknesses are independent such that the thickness of the first substrate may be the same as or different from the thickness of the second substrate.

Electrically conductive layers 15 and 25 may be formed from metals such as gold or conductive metal oxides known in the art such at indium tin oxide (ITO) using known thin film deposition techniques such as for example sputtering, plasma coating methods such as PVD and PECVD and the like. One of ordinary skill will appreciate that the such conductive layers can impact the total % VLT of a coated substrate when applied thereto, with such impact (if any) depending on a variety of factors such as for example selection of layer deposition technique, layer material and layer thickness.

The device of the present invention includes an electrochromic assembly 30 that includes at least one electrochromic layer 35. The at least one electrochromic layer, as well as the electrochromic layers described below, may be formed from and include any known electrochromic material. Suitable electrochromic materials for the electrochromic layer are well known in the art. Examples of suitable materials include, but are not limited to, tungsten oxides, polymer-dispersed liquid crystal (PDLC) material, transition metal oxides such as nickel oxide, polyanilines, and viologens, or the like such as described in U.S. Patent Publication No. 20180173035A1, the contents and description of which are hereby incorporated herein by reference. Particularly suitable electrochromic materials for the electrochromic layer 35 include materials such as Prussian blue (PB), organo-metallic polymers such as metallo-supramolecular coordinating polyelectrolytes (MEPE), and metal oxides.

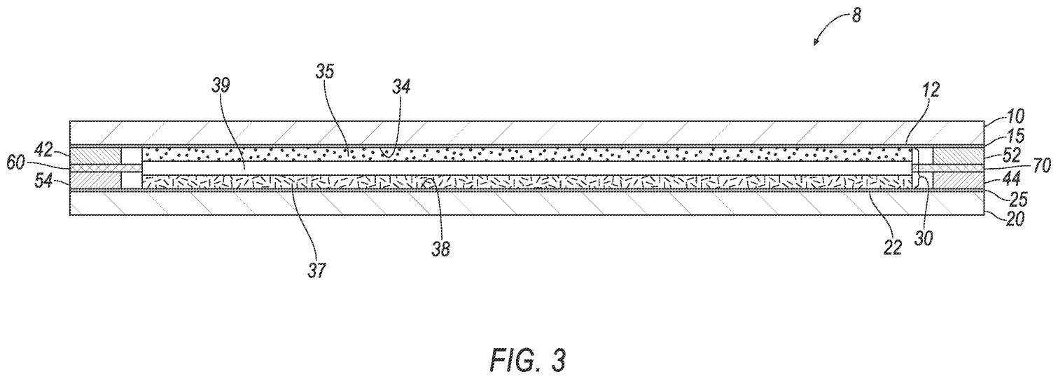

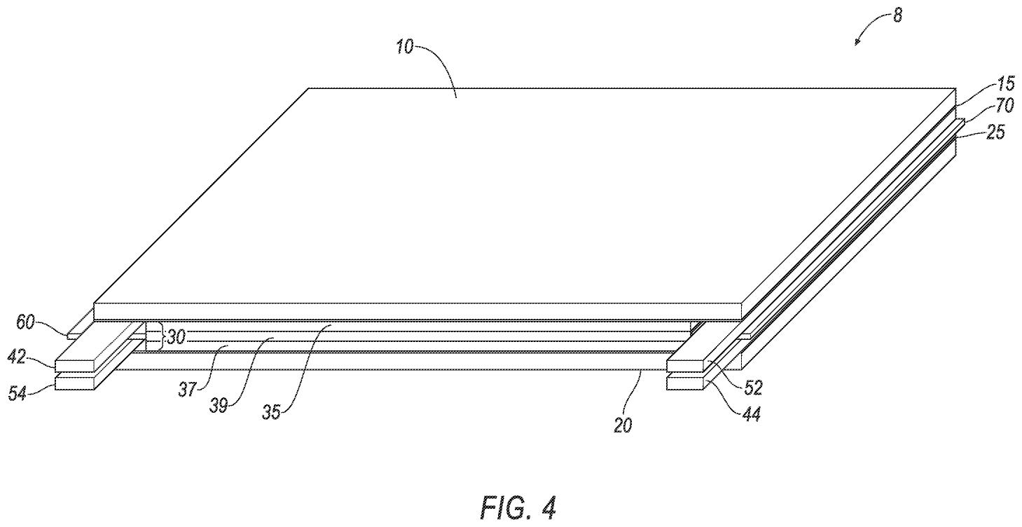

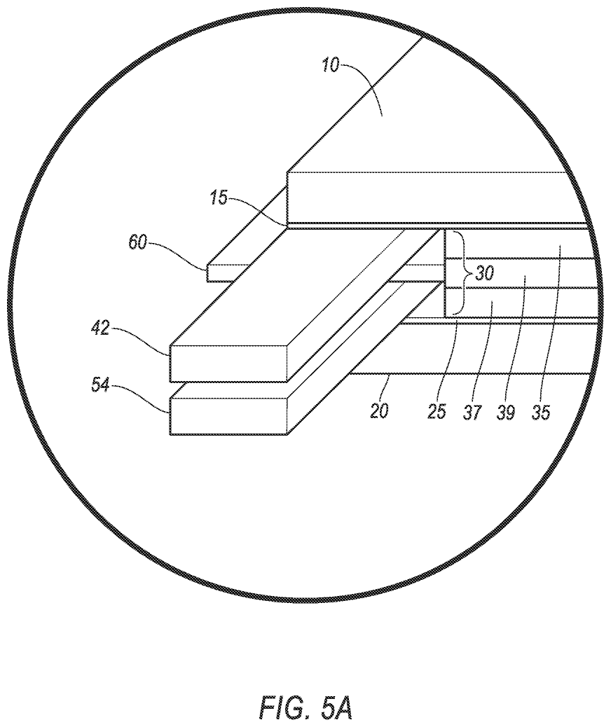

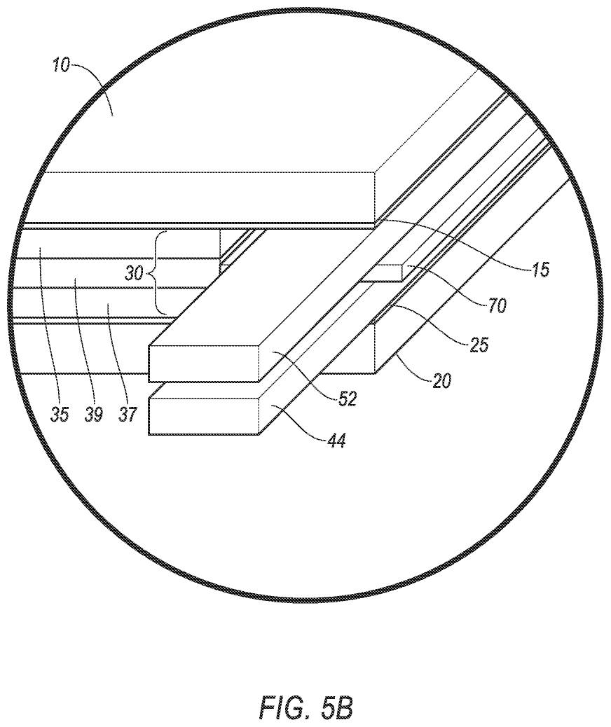

As shown in FIGS. 3 and 4, an embodiment of the electrochromic assembly of the device 30 includes (a) a first electrochromic layer 35 on an inner surface 34 of the electrically conductive layer 15 of the first substrate 10; (b) an ion conducting layer 37 on an inner surface 38 of the electrically conductive layer 25 of the second substrate 20; and (c) an electrolyte layer 39 between the first electrochromic layer 35 and the ion conducting layer 37. The first electrochromic layer 35 and the ion conducting layer 37 may be the same or different materials. In a preferred embodiment, the ion conducting layer 37 is a second electrochromic layer.

The electrolyte layer may be formed from and include any known electrolyte material useful in electrochromic devices. Suitable electrolyte materials for the electrolyte are well known in the art. Particularly suitable electrolyte materials include poly(methyl methacrylate) (PMMA)-lithium perchlorate (LiClO₄) based solid polymer electrolytes plasticized by propylene carbonate, dimethyl carbonate, and polyethylene glycol.

The device 8 of the present invention further includes a first bus bar pair which includes a positive bus bar 42 electrically connected to, and preferably mounted on, the electrically conductive layer 15 of the first substrate 10 and a negative bus bar 44 electrically connected to, and preferably mounted on, the electrically conductive layer 25 of the second substrate 20.

The device of the present invention further includes a second bus bar pair which includes a positive bus bar 52 electrically connected to, and preferably mounted on, the electrically conductive layer 15 of the first substrate 10 and a negative bus bar 54 electrically connected to, and preferably mounted on, the electrically conductive layer 25 of the second substrate 20.

As used herein, the phrase “bus bar” refers to a conductive strip, electrically connected to both an external lead and an electrically conductive layer of the present invention, to deliver a voltage potential or current from the external lead. Bus bars are known generally in the art and are described for example in U. S. Published Patent Application No. 2017/0097553 and U.S. Pat. No. 8,717,658, the contents and disclosure of which are hereby incorporated herein by reference.

In an embodiment, at least one of the bus bars is a conductive tape that includes a conductive substrate with adhesive on at least one of the top and bottom surface thereof. In other embodiments, the conductive strip tape without an adhesive may be used.

One of ordinary skill will appreciate that various physical arrangements of and positions for the bus bar pairs may be contemplated, depending in part for example on the geometric shape of the electrochromic device. In an embodiment, shown in FIGS. 3 and 4, device 8 is generally quadrilateral (including rectangular or square) in shape and the bus bars are generally linear strips with the positive bus bar of the first bus bar pair generally parallel to the positive bus bar of the second bus bar pair. In this embodiment, the electrochromic device of the present invention preferably further includes an insulating layer 60, 70 between and electrically separating the positive bus bars 42, 52 and the negative bus bars 44, 54. The insulating layer is typically formed from materials known as electrical insulators in the art such as polymers and plastics (such as polyethylene terephthalate and polyamide films) and have a thickness and structure sufficient to prevent electrical current from flowing between the bus bars that they separate. In this arrangement, it will be appreciated that the placement of the negative and positive bus bars of a bus bar pair as shown in FIGS. 3 and 4 may be interchanged.

In an embodiment shown in FIG. 4, device 8 is generally quadrilateral (including rectangular or square) in shape and the bus bars are generally linear strips with the positive bus bar 42 generally perpendicular to the positive bus bar 52. In another embodiment (not shown), device 8 is generally quadrilateral (including rectangular or square) in shape and the bus bars are generally perpendicularly angled strips located generally at the corners of the device.

In use, the device of the present invention is operably attached to at least one external voltage potential source with at least one positive lead and at least one negative lead. When a voltage potential is applied between the positive bus bar and the negative bus bar of first bus bar pair as well as between the positive bus bar and negative bus bar of the second bus bar pair via connection of the positive and negative bus bars to the respective positive and negative leads of the external voltage potential source, one or more optical properties of the device reversibly changes. Similarly, when an applied voltage potential between the positive bus bar and the negative bus bar of first bus bar pair as well between the positive bus bar and negative bus bar of the second bus bar pair via connection of the positive and negative bus bars to the respective positive and negative leads of the external voltage potential source is removed, one or more optical properties of the device reversibly changes. Accordingly, a second aspect of the present invention is a process for reversibly changing the optical properties of an electrochromic device that includes at least one electrochromic layer. The process of the present invention includes (i) applying a voltage potential across a first bus bar pair in electrical connectivity with the at least one said electrochromic layer, wherein the first bus bar pair includes a first positive bus bar and a first negative bus bar; and (ii) applying a voltage potential across a second bus bar pair, said second bus bar pair comprising a second positive bus bar and a second negative bus bar. The process may further include the step of (iii) removing at least one of the voltage potentials applied in steps (i) and (ii).

The following examples set forth suitable and/or preferred methods and results in accordance with the invention. It is to be understood, however, that these examples are provided by way of illustration and nothing therein should be taken as a limitation upon the overall scope of the invention.

### EXAMPLES

### Example 1— Sample Preparation

A sample of an electrochromic device of the present invention, with a construction as depicted in FIG. 3 and having a rectangular shape and dimensions of 0.10 m×0.50 m, was constructed. Materials and specifications for the various components were as follows:

Substrates: PET film, 50 microns

Conductive coatings: Gold coating sealed with ITO coating to improve scratch resistance

Electrochromic layers: negative electrochromic layer: Prussian blue (PB), positive electrochromic layer: metallo-supramolecular polyelectrolytes (MEPE)

Electrolyte layers: Lithium ion-based electrolyte materials

Bus bar pairs (2): ½″ width copper electrical tape produced by 3M (Ruban Isolant Cinta Aisladora)

Insulation film: PET film with a thickness of 50 microns

A control sample for comparison purposes, with a construction as depicted in FIG. 1 and having a rectangular shape and dimensions of 0.10 m×0.50 m, was also constructed. Materials and specifications for the various components were as the same as for the device of the present invention with the exception that the control sample contained only one bus bar pair.

### Example 2— Evaluation of Switching/Transition Speed

Switching behavior of the electrochromic devices assembled in Example 1 were evaluated using a Keysight B2901A SMU (source-measure unit) power source. Voltages of +1.7 and 0.0 were used to bleach and color the electrochromic devices, respectively. A square shape voltage profile was applied with 300 second hold periods at both the bleaching and coloring voltage levels. Transmission level (% T) was continuously monitored in the center of the device at a wavelength of 580 nm using a fiber spectrometer (Ocean Optics) when +1.7 V and 0.0 V were applied to the bus bars pairs using the SMU power source. The light source of the fiber spectrometer was projected at the device in a direction perpendicular to the sample front surface and recorded on the back surface of each electrochromic device (the side opposite that of the impinging light source).

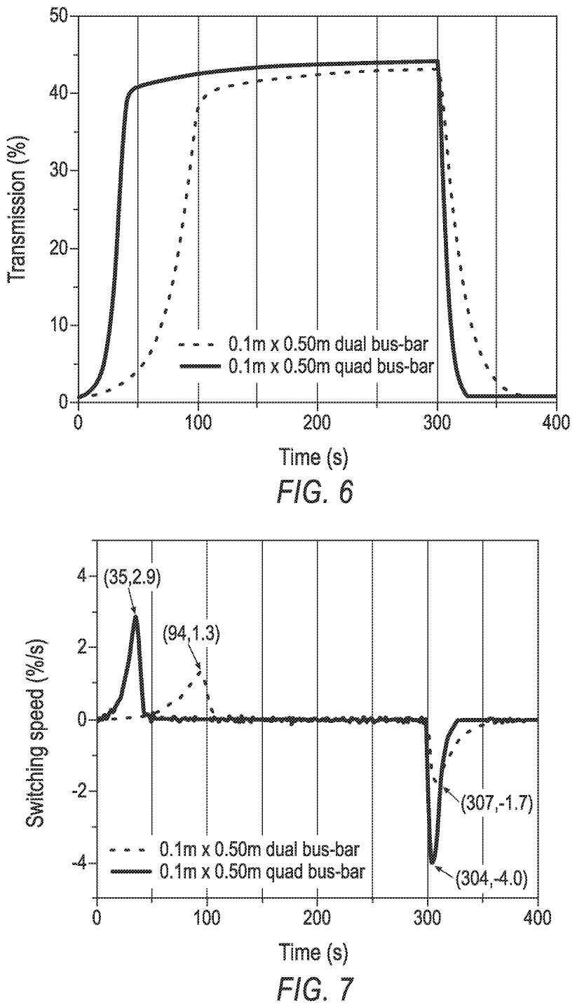

Switching speed was then evaluated according to three parameters: (1) percent bleaching/coloring per second, indicative of how fast a sample achieves a maximum bleaching/coloring rate; (2) % T at 580 nm as a function of time; and (3) total time to maximum bleaching/coloring. The results of the evaluations are shown in FIGS. 6 and 7. As evidenced by these graphs in FIGS. 6 and 7, the device of the present invention achieves maximum bleaching rate of 2.9% per second after applying a voltage of +1.7 V for about 35 seconds and a maximum coloring speed of 4.0% per second after applying a voltage of 0.0 V for only about 4 seconds. In comparison, in the control sample the maximum bleaching speed or coloring rates are 1.3% per second and 1.7% per second respectively—surprisingly and markedly lower than the device of the present invention. Further, the total time required for full bleaching and coloring was surprisingly shorter for the device of the present invention when compared to the control device. Full bleaching was achieved in about 40 seconds for the device of the present invention versus about 120 seconds for the control device. Full coloring time was achieved in about 25 seconds for the device of the invention versus about 65 seconds for the control device.

The foregoing description of various embodiments of the invention has been presented for purposes of illustration and description. It is not intended to be exhaustive or to limit the invention to the precise embodiments disclosed. Numerous modifications or variations are possible in light of the above teachings. For example, it can be contemplated that the present invention may be useful in other fields and applications wherein devices generally respond in some way to application of a voltage potential (for example thermoelectric devices) as well as fields and applications wherein optical properties reversibly switch on application/removal of a voltage potential other than via chemical oxidation/reduction (for example, polymer-dispersed liquid crystal (PDLC) devices). Nonetheless, the embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An electrochromic device comprising:
(i) a first substrate with an electrically conductive layer on an inner surface thereof;
(ii) a second substrate with an electrically conductive layer on an inner surface thereof;
(iii) an electrochromic assembly comprising at least one electrochromic layer;
(iv) a first bus bar pair, said first bus bar pair comprising a positive bus bar electrically connected to said electrically conductive layer of said first substrate and a negative bus bar electrically connected to said electrically conductive layer of said second substrate; and
(v) a second bus bar pair, said second bar pair comprising a positive bus bar electrically connected to said electrically conductive layer of said first substrate and a negative bus bar electrically connected to said electrically conductive layer of said second substrate.

2. The electrochromic device of claim 1 wherein said electrochromic assembly comprises:
(a) a first electrochromic layer on an inner surface of said electrically conductive layer of said first substrate;
(b) an ion conducting layer on an inner surface of said electrically conductive layer of said second substrate; and
(c) an electrolyte layer between said first electrochromic layer and said second electrochromic layer.

3. The device of claim 1 wherein said device is quadrilateral in shape and said positive bus bar of said first bus bar pair is generally parallel to said positive bus bar of said second bus bar pair.

4. The device of claim 3 further comprising a first insulating layer between and electrically separating said positive bus bar of said first bus bar pair and said negative bus bar of said second bus bar pair and a second insulating layer between and electrically separating said positive bus bar of said second bus bar pair and said negative bus bar of said first bus bar pair.

5. The device of claim 1 wherein said device is quadrilateral in shape and said positive bus bar of said first bus bar pair is generally perpendicular to said positive bus bar of said second bus bar pair.

6. The device of claim 2 wherein said ion conducting layer is a second electrochromic layer.

7. A process for changing the optical properties of an electrochromic device comprising at least one electrochromic layer, said process comprising:
(i) applying a voltage potential across a first bus bar pair in electrical connectivity with said electrochromic layer, said first bus bar pair comprising a first positive bus bar and a first negative bus bar; and
(ii) applying a voltage potential across a second bus bar pair, said second bus bar pair comprising a second positive bus bar and a second negative bus bar.

8. The process of claim 7 further including the step of (iii) removing at least one of said voltage potentials applied in steps (i) and (ii).

9. An electrochromic device comprising:
(i) a first substrate with an electrically conductive layer on an inner surface thereof:
(ii) a second substrate with an electrically conductive layer on an inner surface thereof;
(iii) an electrochromic assembly comprising at least one electrochromic layer, wherein said electrochromic assembly comprises:
(a) a first electrochromic layer on an inner surface of said electrically conductive layer of said first substrate;
(b) an ion conducting layer on an inner surface of said electrically conductive layer of said second substrate; and
(c) an electrolyte layer between said first electrochromic layer and said ion conducting layer;
(iv) a first bus bar pair, said first bus bar pair comprising a positive bus bar electrically connected to said electrically conductive layer of said first substrate and a negative bus bar electrically connected to said electrically conductive layer of said second substrate; and
(v) a second bus bar pair, said second bar pair comprising a positive bus bar electrically connected to said electrically conductive layer of said first substrate and a negative bus bar electrically connected to said electrically conductive layer of said second substrate.

10. The device of claim 9 wherein said device is quadrilateral in shape and said positive bus bar of said first bus bar pair is generally parallel to said positive bus bar of said second bus bar pair.

11. The device of claim 10 further comprising a first insulating layer between and electrically separating said positive bus bar of said first bus bar pair and said negative bus bar of said second bus bar pair and a second insulating layer between and electrically separating said positive bus bar of said second bus bar pair and said negative bus bar of said first bus bar pair.

12. The device of claim 9 wherein said device is quadrilateral in shape and said positive bus bar of said first bus bar pair is generally perpendicular to said positive bus bar of said second bus bar pair.

13. The device of claim 9 wherein said ion conducting layer is a second electrochromic layer.

14. (canceled)

15. The process of claim 9, wherein the electrochromic device comprises at least two electrochromic layers.

16. (canceled)
